(19) United States
(12) Patent Application Publication
(10) Pub. No.: US 2025/0052058 A1
(43) Pub. Date: Feb. 13, 2025

(54) APPARATUS FOR INSTALLATION BETWEEN AN INTERNAL WALL TO A BUILDING FACADE AND A METHOD THEREFOR

(71) Applicant: Studco Australia Pty Ltd., Croydon South (AU)

(72) Inventors: Simon Mark McKechnie, Croydon South (AU); Benjamin Gordon Stevens, Croydon South (AU)

(21) Appl. No.: 18/797,024

(22) Filed: Aug. 7, 2024

(30) Foreign Application Priority Data
Aug. 8, 2023 (AU) 2023902502

(51) Int. Cl. E04B 2/74

(52) U.S. Cl. CPC E04B 2/7412; E04B 2/7411

(57) ABSTRACT

Apparatus (100) for fitting as an installation between an internal wall (159) of a building and a façade (170) of said building in order to seal a gap (175) between said internal wall (159) and said façade (170), the apparatus (100) including a building profile (101) having a first member (113) and a second member (115) integrally formed with said first member (113), and a first resilient and intumescent component (124) fitted to said first member (113) and abutting against said façade (170), wherein said apparatus (100) provides and maintains an acoustic and intumescent seal between said internal wall (159) and said façade (170).

### FIELD OF THE INVENTION

This invention relates to an apparatus for fitting as an installation between an internal wall of a building and an external façade of the building and to a method of installing the apparatus between the internal building wall and the building façade.

### BACKGROUND OF THE INVENTION

High rise buildings, such as residential apartments, require many different building elements to come together seamlessly in order to successfully achieve structural adequacy and design intent. One particular junction, where uniquely different building elements come together, is on the internal face of the building façade, where it meets an internal partition wall. Not only do these two elements have unique performance requirements but the fire rating mechanisms of the overall structure needs to be considered along with the desired interior finish. Added to this is another layer of complexity at this junction. When used on walls within the same apartment, a seal between the wall and the façade that limits the transmission of noise must also be able to accommodate thermal expansion and contraction of the façade, together with lateral deflection caused by inter-storey drift and seismic events, all whilst remaining structurally adequate to withstand the internal design pressure of the room. When used on walls between different apartments, this junction also needs to aid in restricting the spread of fire from one apartment to another.

For many years this junction, between the internal face of the building façade and the internal partition wall, has been the cause of consternation for the construction industry. Finding a solution to accommodate the above mentioned characteristics is paramount to the building's integrity and compliance, yet it has a complex combination of competing needs; what stops the spread of fire may not be structural sound, what is structurally adequate may not allow movement, what permits movement may not stop noise, what is acoustically isolated may not be suitable for fixing to a lightweight wall, and what is right for internal walls may have an undesirable interior finish. In this highly nuanced junction, a failure to holistically address each facet is likely to result in reduced performance of the building elements and possibly lead to defects.

The most common current method for addressing the needs of the wall-to-façade connection at present is to construct an internal partition wall that stops a short distance (about 20 mm) away from the internal (or back) face of the façade, creating a gap. A ‘backing foam rod’ is inserted into the gap and sealant is applied to the resulting void to create a non-rigid finished surface between the internal wall and the façade. Sealants used for this purpose are generally viscous materials that bond to the surfaces to which they are applied and once cured, they provide a mechanical seal between those surfaces.

There are a number of shortcomings with this method, including:
a. Non-compliance to serviceability limit state criteria—According to marketing material for common fire-rated acoustic sealants on the market, they can accommodate up to +/−20% movement. So a 20 mm gap filled with sealant can expand and contract 4 mm. Recommended serviceability limit state criteria for windows, facades and curtain walls in Australia, for example, is span/250 (AS 1170.0:2002 Table C). For a common floor-to-floor height of 3.0 metres, facades designed in accordance with the standard will require a minimum +/−12 mm movement (3000/250=12). Even the most flexible sealants cannot meet the minimum performance requirements, falling short by 67%.
b. Increased fire risk and/or noise transmission—In regions where high wind events occur regularly, such as Melbourne, Australia, or Wellington, New Zealand, the façade is under dynamic pressure resulting in building movement. There can be a tendency for such sealants to delaminate at the edges, either due to repetitive movement or a significant movement event such as an earthquake, resulting in a gap at the edge of the sealant. Such a gap would compromise the integrity of fire protection or acoustic properties of the sealant and may lead to catastrophic failure of the wall-to-façade connection.
c. Incorrect product choice—Not all fire-rated acoustic sealants are equal. Some common sealants that are used in this particular junction are advertised as accommodating movement “up to 12.5%” without stating whether this is combined movement or in each direction. Assuming that this is in one direction only, a 20 mm gap filled with this sealant is suitable for a maximum movement of 2.5 mm; some 58.3% below the minimum performance requirement. By selecting a product with such a restrictive level of flexibility, the wall-to-façade connection may be subject to increased fire risk, increased noise transmission and loss of amenity to the liveable space. Additionally, the prospect of the unpleasant appearance of gaps appearing in such spaces is likely to lead to latent defect claims.
d. Incorrect coverage in application—Applying sealant by hand to an internal wall-to-façade connection has many variables that are difficult to control at the time of application. A correct depth of sealant must be considered in order to achieve a particular fire rating. According to one manufacturer's publicly available fire tests, a 20 mm×26 mm bead of sealant will provide a two-hour fire rated junction. However, the same manufacturer states that a bead of sealant that is only half as deep (13 mm) will only provide a one-hour fire rating. It is practically impossible to confirm the depth of the sealant once it has been applied and should even only a small portion of the sealed gap be of insufficient depth, this portion is likely to fail first and compromise the entire junction.
e. Requires skilled labour—Whilst the application of caulking may not seem overly complicated, the preceding explanations show there are many complex factors that need to be considered in applying it and the trade is considered a skilled trade. This is no more apparent than in the rates charged by professional caulkers and in the shortage of such tradespeople at present. At present, the application of fireproofing sealants is not a licensed trade in Australia at least, but there has long been a debate whether it should be and the industry is moving towards increased accountability around fire proofing, not less.
f. Not practical for all situations—To correctly apply a sealant to the wall-to-façade connection, the person applying the sealant needs to be able to sufficiently access the junction. Sealant is applied to the junction through a narrow nozzle attached to a caulking gun. Once the sealant has been applied, it is then common to undertake some manual function to smooth or shape the visible surface of the sealant to enhance its aesthetic appearance. Therefore, for a successful application to the wall-to-façade connection, the person must first be able to get his/her caulking gun into the correct position and then must be able to have a method of accessing the junction to finish it. Some complex wall-to-façade connections are simply not accessible.
g. Near impossible architectural details—In some cases, the internal wall requires fireproofing at the end of the wall by way of fixing a piece of fire-rated plasterboard parallel to the façade. Not only is it practically impossible to screw fix this board to the end of the studs (at the end of the internal wall) but it also causes a flanking path for sound between the rooms on either side of this wall. To overcome the flanking issue, acoustic engineers provide an alternative detail at the wall-to-façade connection (including a pair of fire-rated plasterboard sections parallel to the external façade with a small gap in between) which satisfactorily addresses acoustics but is considered more impractical than the original construction method, as the additional sealant located between the two plasterboard pieces at the wall end would be almost impossible to apply and achieve satisfactory adherence. Doing this at all of the wall ends to a repeatable quality level would be extremely difficult to achieve.
h. Long curing time—Sealant manufacturers recommend a variety of curing times, the longest curing times being in winter. Any unforeseen impact on or interaction with the sealant during the curing time may compromise the integrity of the junction, so typically on building sites where sealant has been recently applied, these areas are designated as ‘no go’ zones for up to several days and follow up trades cannot function in those areas.
i. Challenging construction sequence—Due to the nature of the sealed junction at the wall-to-façade connection, it is necessary that the sealant is applied as one of the final operations on the building schedule. The application of sealants is generally done after painting is completed and after carpets are installed. This means that a relatively messy procedure is required at the end of the building process. Any sealant that may accidentally spread on to the finished painted surfaces may require extensive cleaning and should sealant accidentally drop onto the carpet, it would be extremely difficult to remove.
j. Sub-optimal appearance—Even with an experienced and skilled applicator, a perfect finish at the sealed wall-to-façade connection is extremely difficult to achieve, leading to architects, developers and residents alike often expressing disappointment at the appearance of this junction. A fully visible bead of manually applied sealant, at least 20 mm wide and often wider, is less than desirable in a modern apartment or office. It is also common for bubbling to appear on the surface and/or slumping that has occurred during the curing process due to over-application. Sealant manufacturers also note in their marketing material that it is common for some shrinkage to occur during curing which may result in unsightly gaps appearing at the edges of the sealant.

The present invention seeks to overcome at least one of the above disadvantages by providing a method and an apparatus for connecting an internal wall of a building to an external façade of the building that does not require any sealant and, therefore time for the sealant to cure and the possibility of any stray sealant ending up on the finished wall surface or floor, including carpet.

### SUMMARY OF THE INVENTION

According to a first aspect of the invention, there is provided apparatus for fitting as an installation between an internal wall of a building and a façade of said building in order to seal a gap between said internal wall and said façade, the apparatus including:
a building profile having a first member and a second member integrally formed with said first member; and
a first resilient and intumescent component fitted to said first member and abutting against said façade;
wherein said apparatus provides and maintains an acoustic and intumescent seal between said internal wall and said façade.

The first member preferably includes a first web portion and a first flange extending from said first web portion. Preferably the second member is a second flange enabling attachment of the apparatus to said internal wall.

The apparatus may further include a second web portion formed in said first member and integrally formed with said first web portion and separated by a common side wall.

The first web portion and the second web portion are preferably offset from one another. The second flange may extend from said second web portion. The second flange preferably includes a side section, a connecting section and a ramp section between the connecting section and the side section.

According to an embodiment, the connecting section has apertures to enable fastening means to attach said apparatus to a part of said internal wall. The side section is preferably located between the second web portion and the ramp section, the ramp section also formed with said connecting section. The ramp section can provide an offset between the connecting section and the side section such that, when installed, the connecting section is positioned against the internal wall, and plaster is able to be applied over said connecting section up to and including the ramp section.

The apparatus may further include a first receiving section formed by said first web portion, said first flange and said common side wall. The apparatus may further include second receiving section formed by said second web portion, said common side wall and said second flange. The apparatus may further include a second and a third resilient and intumescent component. Preferably said first component fits into said first receiving section and is adhesively attached to an inner face of said first web portion.

Preferably the first flange and said common side wall are directed inwardly towards one another with respect to said first web portion and provide a tensioned frictional engagement with said first component to assist in retaining the first component in said first receiving section.

The first component may be installed in a partially compressed state and is adapted to compress further in response to the façade undertaking a movement towards the internal wall and is adapted to expand in response to the façade undertaking a movement away from the internal wall, said movement being forced by external environmental conditions.

Preferably the third component is located between an outer face of said first web portion and an outer end of said internal wall, said third component adhesively attached to said outer face of said first web portion. The second component is preferably located in said second receiving section and between the second web portion and the outer end of said internal wall, said second component adhesively attached to an inner face of said second web portion and aligned with said third component against said outer end of said internal wall.

The first web portion and the second web portion preferably have different widths in order to fit to differently sized internal walls. The second flange may be at an angle other than perpendicular with respect to the second web portion to fit against an internal wall that is not perpendicular to said façade.

The first component, the second web portion and a part of said façade preferably create a recess in the form of a shadowline between the end of the internal wall and the façade when the internal wall is in a final and finished state.

The apparatus preferably forms an air-tight seal between the internal wall and the façade and at least said first resilient and intumescent component is positioned to limit or eliminate the transfer of sound, fire and air between adjacent rooms or apartments separated by said internal wall.

The first, second and third resilient and intumescent components can swell or expand when exposed to heat or fire in order to maintain the seal between the internal wall and the façade.

According to a second aspect of the invention, there is provided a method of installing apparatus between an internal wall of a building and a façade of said building in order to seal a gap between said internal wall and said façade, the apparatus including a building profile having a first member and a second member integrally formed with said first member; and a first resilient and intumescent component fitted to said first member; said method including the step of:
positioning the apparatus between the façade and an outer end of the internal wall such that the first resilient and intumescent component abuts against said façade; and
securing the second member to said internal wall at various locations along the length of the second member;
wherein said apparatus provides and maintains an acoustic and intumescent seal along the entire interface between said internal wall and said façade.

### BRIEF DESCRIPTION OF DRAWINGS

A preferred embodiment of the invention will hereinafter be described, by way of example only, with reference to the accompanying drawings, in which:

FIG. 1 is a perspective view of a building profile having a first member and a second member;

FIG. 2 is a perspective view of the apparatus according to one embodiment having the profile in FIG. 1 as well as resilient intumescent material secured thereto;

FIG. 3 is a perspective view from above of the apparatus of FIG. 2, installed as a pair, between an internal wall and a façade of a building;

FIG. 4 is a plan view of the apparatus shown in FIG. 2;

FIG. 5A is a plan view of apparatus similar to that shown in FIG. 4 with a second web portion extended to accommodate a wide internal partition wall;

FIG. 5B is a plan view similar to FIG. 4 but showing a second flange at an acute angle with respect to one edge of a resilient and intumescent component of the apparatus;

FIGS. 6A to 6E are a series of sequential diagrams that show various stages of installation of the apparatus between an internal wall and a façade of a building and includes the various states of movement of the façade with respect to the internal wall; and

FIGS. 7A and 7B are perspective views of a finished internal wall and a shadowline that exists between the wall end and the external façade of the building.

### DETAILED DESCRIPTION OF PREFERRED EMBODIMENT

The present invention is a singular device that once installed is intended to remove the need for the manual application of sealant at the internal wall-to-façade connection. Rather than treating the internal partition wall and the façade as two separate elements that requires a manual process at the end of the construction phase to bring these two elements together, the invention is designed to be installed in sequence with the internal walls and forms part of the internal wall system.

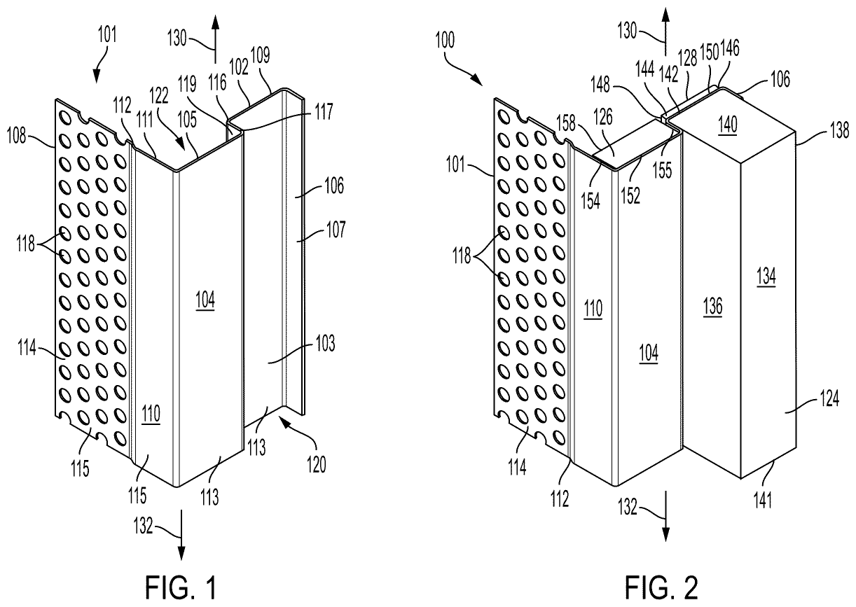

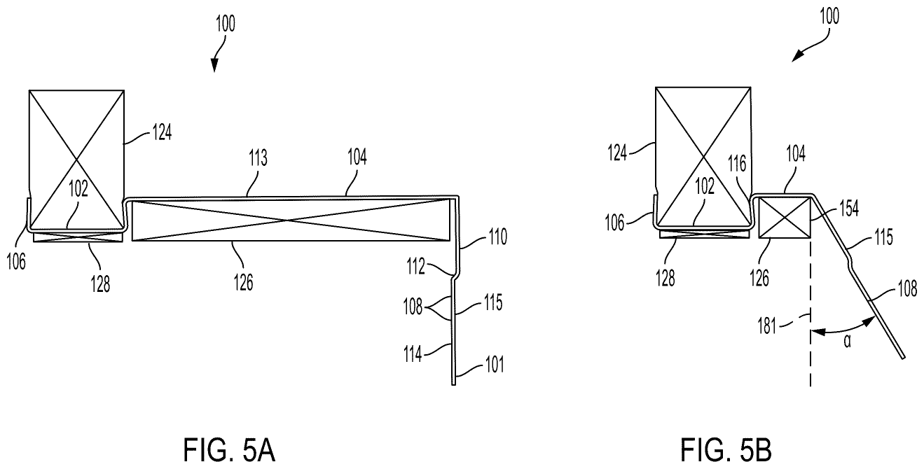

Referring to FIGS. 1, 2 and 4 there is shown apparatus 100 that fits between and connects the outer end of an internal wall in a building to an internal face of the building façade, which forms part of an outer wall of a building. The apparatus 100 is a unitary device made from suitable metal or plastic that extends along the whole length/height of the outer end of the internal wall and end section of plasterboard panels near the outer end. It includes a building profile 101 that has a first member 113 and a second member 115 substantially perpendicular to the first member 113. The first member 113 includes a first web portion 102 (in a preferred embodiment) and a second web portion 104, each of the web portions 102, 104 sharing a common side wall 116. The second web portion 104 is offset from the first web portion 102 by side wall 116. A first flange 106 extends outwardly from first web portion 102 of which its outer edge 107 is approximately in line with the second web portion 104. The second member 115 is essentially made up of a second flange 108 that extends from the second web portion 104 in the opposite direction to first flange 106. The second flange 108 includes a side section 110, a connecting section 114 and a ramp section 112 which joins both sections 110 and 114. Both the sections 110 and 114 are essentially in parallel planes, but offset to one another, the offset created by the ramp section 112 which makes side section 110 protrude slightly further outwardly from the second web portion 104 compared to section 114.

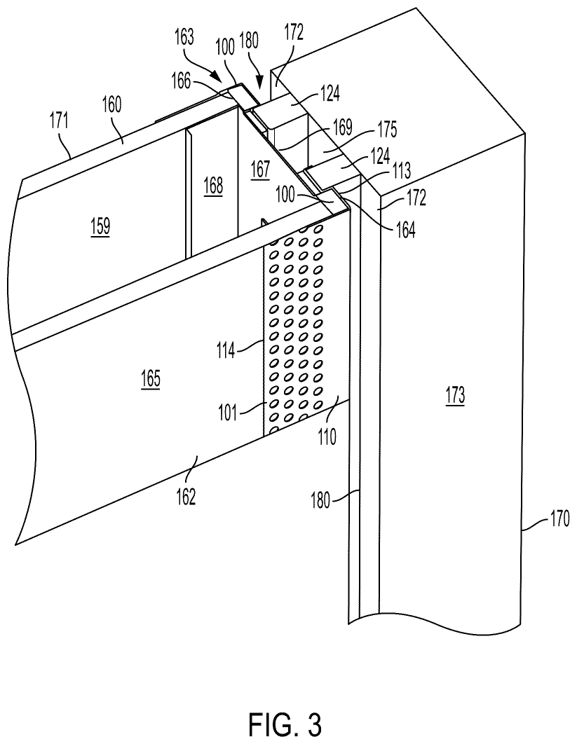

The first flange 106 and the side wall 116 extend inwardly toward each other compared to the web portion 102 to provide tension to grip a further component to be described in relation to FIG. 2. The first web portion 102, the first flange 106 and the side wall 116 form a first recess or receiving section 120. The second web portion 104, side wall 116 and side section 110 form a second recess or second receiving section 122.

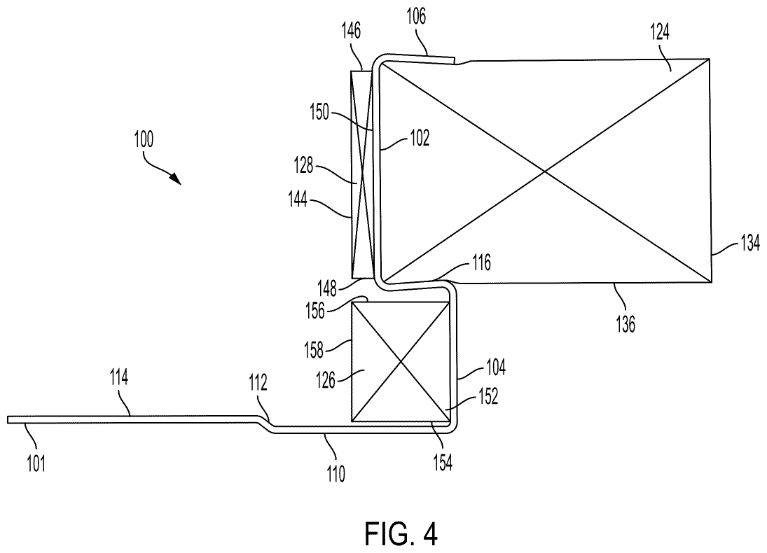

Referring to FIG. 2 there is shown the apparatus 100 fitted with a resilient component 124, which is also intumescent and, as an example, is a type of foam that is airtight, watertight, compressible, resilient and able to seal. Being intumescent, in case of heat or fire, it is able to swell or expand and harden in order to substantially reduce or prevent fire, heat and smoke being transmitted to an adjoining room or apartment. The component 124 is also able to dampen vibrations and is conformable to uneven surfaces. It is made ready for installation and can have adhesive already applied to one side thereof. The component 124 is positioned and secured within the first receiving section 120 and extends along the entire length/height of the profile 101 in the directions 130 upwardly and 132 downwardly as indicated by the arrows. The component 124 has on a rear face 142 thereof an adhesive material to enable it to be attached to the inner face 103 of the web portion 102. In case, over time, the adhesive deteriorates, the first flange 106 and the side wall 116 are directed inwardly towards one another to contact, secure and grip a portion of the resilient component 124. Through the applied tension, the resilient component 124 is kept in position, as a further mechanism for retaining the component 124 in case the adhesive wears or deteriorates over time. The resilient component 124 also has a top face 140, underneath face 141 and a front face 134 which abuts against the surface of an inside face 172 (FIG. 3) of the façade 170. First side face 136 forms part of a shadowline to be explained hereinafter, while second side face 138 has part of its surface contacting the inner surface 107 of first flange 106. Likewise, the first side face 136 has part of its surface abutting against a first face 117 of side wall 116.

A second resilient and intumescent component 128, much smaller in depth compared to the first resilient and intumescent component 124 and a third resilient and intumescent component 126 (to be described), has a rear face 150 with an adhesive strip to enable it to be adhesively secured to an outer face 109 of first web portion 102. Both of its sides 146 and 148 are essentially in line with faces 136 and 138 of component 124 while the outer, front face 144 of component 128 is in line with the outer, front face 158 of the third resilient and intumescent component 126. Both the faces 158 and 144 sit flush against an end wall component such as a stud 168.

A third smaller resilient and intumescent component 126 fits within the second receiving section 122 formed by the second web portion 104, sidewall 116 and side section 110. It has a rear or inner face 152 that extends all the way along the length/height of the apparatus 100 in the directions 130 and 132. Its rear face 152 has an adhesive strip to enable it to be adhesively secured to an inner face 105 of the second web portion 104, while first and second side faces 154 and 156 have all or part of their surfaces respectively secured to inner surface 111 of side section 110 and second face 119 of sidewall 116. That is, side face 156 of the component 126 is secured to second face 119. For added security, the side face 119 may be directed inwardly slightly towards surface 111 to secure the component 126 in the case that the adhesive on component 126 wears over time or deteriorates. The third component 126 is aligned with said second component 126 against said outer end 163 of said internal wall 159, and in particular against the outer side 169 of web 167 of stud 168.

Referring to FIG. 3 there is shown the apparatus 100 including resilient components 124, 126 and 128 installed and connecting an internal wall 159 to the internal face 172 of external façade 170 of a building. The wall 159 has a pair of parallel plasterboards 160 and 162 that terminate at outer end 163 of wall 159 with the web 167 of a stud 168. One apparatus 100 each extends from respective ends 164 and 166 of respective boards 162 and 160.

All three resilient and intumescent components 124, 126 and 128 can be used together in apparatus 100. Alternatively, the first resilient component 124 can be used entirely on its own, or component 124 can be used in combination with the third component 126 or in combination with the second component 128.

The first resilient and intumescent component 124 of each apparatus 100 is initially compressed, either by hand or supplied as compressed using a disposable cap that needs to be removed prior to installation. Component 124 is installed between the outer end 163 of internal wall 159 and inner face 172 of the façade 170. Each third resilient and intumescent component 126 respectively abuts against end 164 of board 162 and end 166 of board 160 and both partially abut against the outer side 169 of web 167 of the stud 168. Each second resilient and intumescent component 128 abuts against the outer side 169 of web 167 of the stud 168. At the same time, the connecting section 114 of each profile 101 abuts against the outer surfaces 165 and 171 of respective boards 162 and 160 and are screwed or secured to those boards through suitable securing means using apertures 118.

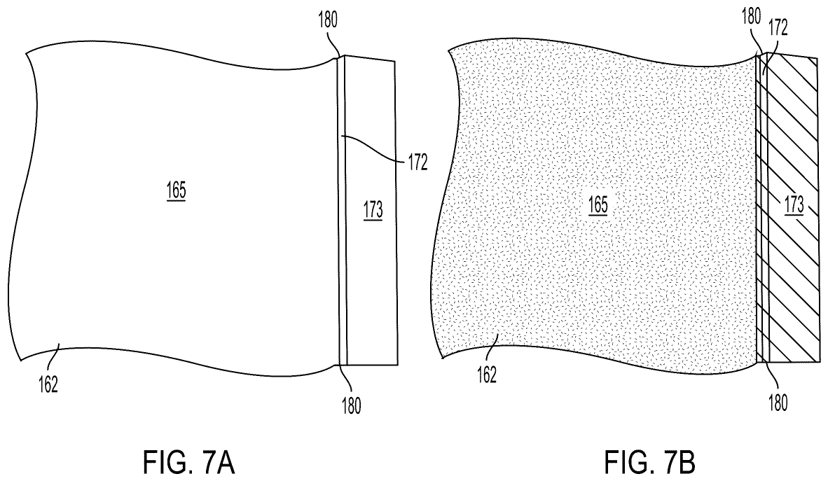

After the apparatuses 100 have been secured to their respective positions, a shadowline 180 is formed on each side of the wall 159 and this is seen in FIGS. 7A and 7B together with a finished surface of the board 162 whereby plaster has been applied and finished to the outer face 165 of board 162 and over the connecting section 114 up to the ramp section 112 to present a smooth surface which is then sanded and painted. The shadowline 180 is between outer surface 165 and sidewall 173 of façade 170.

In order to install the apparatus 100 between internal wall 159 and internal face 172 of external façade 170, the first resilient component 124 is pre-compressed to a depth of 30 mm, as an example only, and the whole apparatus 100 is placed in the gap 175 between the web 167 of stud 168, which is at the outer end 163 of the wall 159, and the inner surface 172 of façade 170. The front face 134 of the component 124 is positioned to be abutting against surface 172 while the other two components 126 and 128 are respectively positioned abutting against the end of the plaster board, for example end 162 and the outer surface 169 of web 167 of stud 168. A pair of apparatuses 100, as shown in FIG. 3, are fitted between the façade 170 and respective plaster boards 160 and 162. The connecting section 114 of the second flange 108 abuts against the exterior surfaces 171 and 165 of the respective plasterboards 160 and 162. Each connecting section 114 is then secured to respective plaster boards 160, 162 through securing means, such as screws, using the apertures 118. This is done at various intervals along the whole height of the internal wall. A check is made to make sure that the apparatus 100 is in place securely and does not move. It is then a matter of plastering the external surface of each plasterboard 160 and 162, such as 165, so that it is flush finished by trowelling a suitable plaster setting compound over the connecting section 114 up to the ramp section 112. Once the plaster setting compound has cured, it is sanded in and around the ramp section 112 so that the remainder of the surface 165 is level with and integral with the side section 110. The exterior surfaces of the plaster boards 160 and 162 are then painted to create the finish to the internal wall 159 as seen in FIGS. 7A and 7B. It leaves an aesthetically pleasing soft shadowline 180 between the end of the partition wall 159 and the internal face 172 of the façade 170 and an overall clean look to the wall 159.

The first resilient and intumescent component 124 forms an air-tight seal between the internal wall 159 and the façade 170 and the resilient and intumescent components 124, 126 and 128 together are positioned to limit or eliminate the transfer of sound, fire and air between adjacent rooms or apartments separated by the internal wall 159. As the façade 170 moves due to high wind events or earth tremors, the main resilient and intumescent component 124 simply compresses and expands to ensure that the void between the internal partition wall 159 and the façade 170 is always sealed. Whilst the component 124 has adhesive backing to bond it to the metal profile 101 in first web portion 102, constant movement of the façade 170 may cause reduced adhesion in some extreme cases. In order to achieve sufficient longevity of the building elements, the main component 124 is also snuggly seated into a profile on the metal section, being the first recess or receiving section 120, formed by first flange 106, sidewall 116 and first web portion 102. This allows dual modular redundancy should the adhesion of the main resilient and intumescent component 124 deteriorate over time. Unlike prior art methods and other foam finishing sections, this embodiment does not rely on the sealant applying pressure to the edge of the plasterboard of the internal wall. The main component 124 of this embodiment is strategically placed on the formed metal profile 101 so that pressure from façade movement is transferred through the main, foam profile, component 124 to the metal framing system of the internal partition wall (such as the stud 168), not the edge of the plasterboard sheeting.

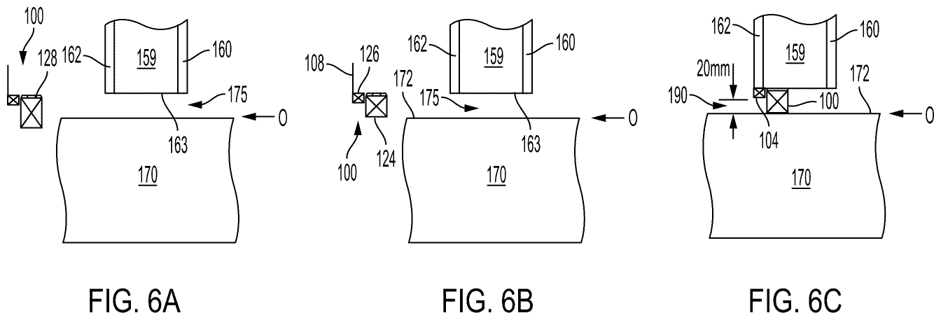

With reference to FIG. 5A and FIG. 5B, the apparatus 100 can be produced in various dimensions and at angles to suit specific applications. For example, in FIG. 5A a wide internal partition wall requires the web portion 104 to be much wider than the web portion 102. Consequently, the second resilient component 126 is made much wider to conform to the size of the web portion 104.

In FIG. 5B the second flange 108 is at an angle compared to the side portion 154 of second resilient component 126. The angle α between the second flange 108 and an extension 181 (dotted line) in the same plane as side portion 154 is an acute angle and can vary between zero degrees and up to about 45 degrees and less than 90 degrees. This is to account for a partition wall that intersects with the façade 170 at an angle other than a right angle as is shown in FIG. 5A. It is seen that the profile 101 and its manufacturing process make this embodiment versatile and easily adaptable to most internal wall to façade connections.

As is generally accepted in construction practices, at least in Australia, there is at least 20 mm set back of the building façade 170 from the end 163 of the internal partition wall 159 at the wall to façade connection. Intumescent and resilient components can accommodate up to 60% compression and have sufficient tolerance to accommodate extreme building movement. At this rate, compliance to AS 1170.0:2002 Table C is achieved. If for example, the depth of the first resilient component 124 from its front face 134 to its back face 142, is 44 mm deep and if it is compressed by 14 mm at the installation, it would be able to accommodate a +/−12 mm movement easily without exceeding its maximum compression properties.

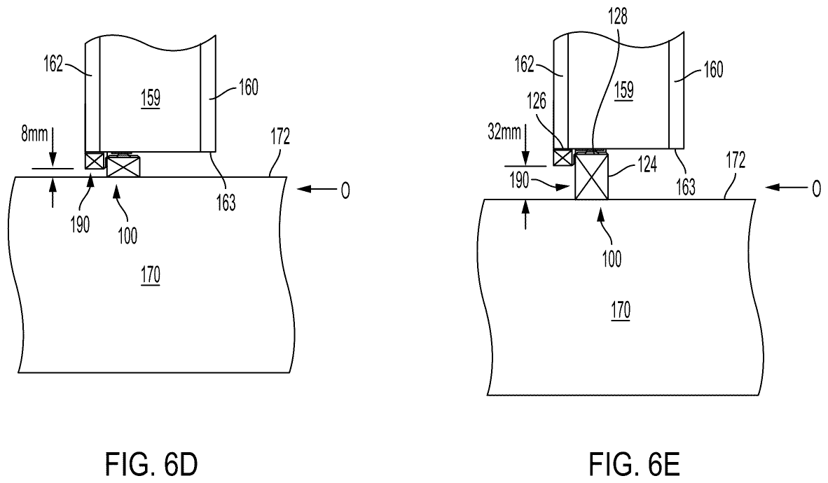

Referring to the series of diagrams in FIGS. 6A to 6E, there is shown various stages of the installation of the apparatus 100 to seal a gap 175 between the internal partition wall 159 and the façade 170 and various states of movement of the façade 170 with respect to the internal partition wall 159. In FIG. 6A the apparatus 100 is shown in its entirety prior to installation between the wall 159 and internal face 172 of the façade 170. FIG. 6B shows the first resilient and intumescent component 124 compressed to 30 mm prior to installation from its original 44 mm depth. This represents 32% compression.

In FIG. 6C, the apparatus 100 is shown installed between the wall 159 and the façade 170. The façade 170 is shown in its “resting position” (zero position) with the gap 190 between the interior face 172 of façade 170 and second web portion 104, being 20 mm.

Referring to FIGS. 6D, pressure is applied to the apparatus 100 when the building façade 170 moves inwards towards the wall 159 so that the resilient component 124 is compressed by 12 mm from its resting position. Thus it has been compressed from 30 mm to 18 mm which represents 59% compression. This leaves the gap 190 at 8 mm.

In FIG. 6E the drawing shows the apparatus 100 installed but under lateral suction whereby the apparatus 100 is expanded in position due to the façade 170 moving outwardly and away from the internal partition wall 159. Thus the façade 170 has moved outwardly by 12 mm from its rest position so that the gap 190 has increased from 20 mm to 32 mm and the first resilient and intumescent component 124 is only compressed to 42 mm which represents a 4.5% compression value from its original 44 mm. In this situation it has expanded from its rest position of 30 mm to 42 mm.

This embodiment is an assembly of multiple components, including multiple adhesive-backed foam profiles that are affixed to a single formed metal profile (see FIG. 2). Being a single product, correct and compliant installation is significantly more achievable that previous methods and the installer is not left wondering if the correct amount of sealant has been applied and therefore, if the acoustics and fire protection will work. Once the device is installed, the installer can be confident that the device will function correctly and meet the required acoustic and fire prevention properties.

The apparatus 100 forms an air-tight seal between the internal wall 159 and the façade 170 and at least the first resilient and intumescent component 124 is positioned to limit or eliminate the transfer of sound, fire and air between adjacent rooms or apartments separated by the internal wall 159. The second and third resilient and intumescent components 128 and 126 also assist in such limitation or elimination.

Specific disadvantages that this embodiment overcomes compared to previous products and processes include:
a. Increased fire risk and/or noise transmission—The example above demonstrates that this embodiment is able to accommodate even extreme compression and expansion without the risk of creating a gap that might compromise the fire protection properties or acoustic properties of the wall-to-façade connection. In the event that the adhesive backing on at least the main component 124 deteriorates over time, dual modular redundancy has been deployed by providing a mechanical method for holding at least the main component 124 in place, as previously discussed.
b. Incorrect product choice—As this embodiment is a singular product, there is no need for choice thereby eliminating the possibility of selecting an unsuitable product and potentially causing catastrophic consequences.
c. Incorrect coverage in application—As the dimensions of the resilient and intumescent components are generally preset in the manufacturing process, correct and compliant installation is significantly more achievable, and the installer can be confident that the intumescent components will function correctly in the event of a fire.
d. Not practical for all situations—The present apparatus is installed onto the face of the internal partition wall which is perpendicular to the façade, and access into the cavity of the wall-to-façade connection with tools is not required.
e. Near impossible architectural details—Fireproofing to the end of the internal wall is achieved by device 100, without any need to access the end 163 of the wall. Access is only required to the face of the internal partition wall which is perpendicular to the façade 170 and readily accessible.
f. Long curing time—There is no curing required for this apparatus to function correctly after being installed.
g. Challenging construction sequence—The apparatus 100 is installed at the wall-to-façade connection by the plastering tradespeople at the time that the plasterboard finishing sequence occurs at the internal partition walls, along with all other plasterboard finishing sections such as external corners, internal corners and shadowline beads. Once the apparatus 100 is installed, the plaster setting compound has been applied and the surface has been sanded smooth, the installation is complete and there is no need to revisit the wall-to-façade connection later in the construction sequence.
h. Sub-optimal appearance—Once installed, the apparatus creates a shadowline edge 180 at the wall-to-façade connection, which is considered as a premium finish in the architectural finishing industry. The clean lines, the flush finish and the concealed foam seal created by the apparatus 100 are desirable in modern interiors. As the foam profile component 124 is set back from the finished line of the plasterboard on the interior partition wall, it gives the illusion that there is no connection between the interior partition wall 159 and the façade 170. There are no ugly sealant beads that are highly visible to anyone standing near a window.

What is claimed is:

1. Apparatus for fitting as an installation between an internal wall of a building and a façade of said building in order to seal a gap between said internal wall and said façade, the apparatus including:
a building profile having a first member and a second member integrally formed with said first member; and
a first resilient and intumescent component fitted to said first member and abutting against said façade;
wherein said apparatus provides and maintains an acoustic and intumescent seal between said internal wall and said façade.

2. Apparatus according to claim 1 wherein said first member includes a first web portion and a first flange extending from said first web portion.

3. Apparatus according to claim 2 wherein said second member is a second flange enabling attachment of the apparatus to said internal wall.

4. Apparatus according to claim 3 further including a second web portion formed in said first member and integrally formed with said first web portion and separated by a common side wall.

5. Apparatus according to claim 4 wherein the first web portion and the second web portion are offset from one another.

6. Apparatus according to claim 4 wherein said second flange extends from said second web portion.

7. Apparatus according to claim 6 wherein said second flange includes a side section, a connecting section and a ramp section between the connecting section and the side section.

8. Apparatus according to claim 7 wherein the connecting section has apertures to enable fastening means to attach said apparatus to a part of said internal wall.

9. Apparatus according to claim 8 wherein the side section is located between the second web portion and the ramp section, the ramp section also formed with said connecting section.

10. Apparatus according to claim 9 wherein the ramp section provides an offset between the connecting section and the side section such that, when installed, the connecting section is positioned against the internal wall, and plaster is able to be applied over said connecting section up to and including the ramp section.

11. Apparatus according to claim 10 further including a first receiving section formed by said first web portion, said first flange and said common side wall and further including a second receiving section formed by said second web portion, said common side wall and said second flange.

12. Apparatus according to claim 10 further including a second and a third resilient and intumescent component.

13. Apparatus according to claim 12 wherein said first component fits into said first receiving section and is adhesively attached to an inner face of said first web portion.

14. Apparatus according to claim 13 wherein said first flange and said common side wall are directed inwardly towards one another with respect to said first web portion and provide a tensioned frictional engagement with said first component to assist in retaining the first component in said first receiving section.

15. Apparatus according to claim 14 wherein said first component is installed in a partially compressed state and is adapted to compress further in response to the façade undertaking a movement towards the internal wall and is adapted to expand in response to the façade undertaking a movement away from the internal wall, said movement being forced by external environmental conditions.

16. Apparatus according to claim 15 wherein said third component is located between an outer face of said first web portion and an outer end of said internal wall, said third component adhesively attached to said outer face of said first web portion.

17. Apparatus according to claim 16 wherein said second component is located in said second receiving section and between the second web portion and the outer end of said internal wall, said second component adhesively attached to an inner face of said second web portion and aligned with said third component against said outer end of said internal wall.

18. Apparatus according to claim 17 wherein the first web portion and the second web portion have different widths in order to fit to differently sized internal walls.

19. Apparatus according to claim 17 wherein said second flange is at an angle other than perpendicular with respect to the second web portion to fit against an internal wall that is not perpendicular to said façade.

20. Apparatus according to claim 19 wherein said first component, said second web portion and a part of said façade create a recess in the form of a shadowline between the end of the internal wall and the façade when the internal wall is in a final and finished state.

21. Apparatus according to claim 20 wherein said apparatus forms an air-tight seal between the internal wall and the façade and at least said first resilient and intumescent component is positioned to limit or eliminate the transfer of sound, fire and air between adjacent rooms or apartments separated by said internal wall.

22. Apparatus according to claim 21 wherein said first, second and third resilient and intumescent components swell or expand when exposed to heat or fire in order to maintain the seal between the internal wall and the façade.

23. A method of installing apparatus between an internal wall of a building and a façade of said building in order to seal a gap between said internal wall and said façade, the apparatus including a building profile having a first member and a second member integrally formed with said first member; and a first resilient and intumescent component fitted to said first member; said method including the step of:
positioning the apparatus between the façade and an outer end of the internal wall such that the first resilient and intumescent component abuts against said façade;
and securing the second member to the internal wall at various locations along the length of the second member;
wherein said apparatus provides and maintains an acoustic and intumescent seal along the entire interface between said internal wall and said façade.
